(19) United States
(12) Patent Application Publication
(10) Pub. No.: US 2005/0115023 A1
(43) Pub. Date: Jun. 2, 2005

(54) Tricolored handle structure for screwdriver

(76) Inventor: Jack Lin, Nan-Tou (TW)

Correspondence Address: CHARLES E. BAXLEY, ESQ., 90 JOHN STREET, THIRD FLOOR, NEW YORK, NY, 10038, US

(21) Appl. No.: 10/724,930

(22) Filed: Dec. 1, 2003

(51) Int. Cl. E05B 1/00

(52) U.S. Cl. 16/110.1

(57) ABSTRACT

A tricolored handle structure for screwdriver, which is provided along the axial direction with a rod which extends outward from the handle, the handle has a hard-plastic made first core handle integrally melted with a hard-plastic made second core handle and then being coated with a soft third layer, the first core handle has at least a hard first pattern portion, the second core handle has at least a hard second pattern portion, wherein the first pattern portions and the pattern portion are not coated by third layer, the first pattern portion, the second pattern portion and the third layer are different colored and form a smooth surface of the handle.

### BACKGROUND OF THE INVENTION

1. Field of the Invention

The present invention relates to a hand tool, and more particularly to a tricolored handle structure for screwdriver.

2. Description of the Prior Arts

Conventional handle structure for a screwdriver discloses a tool handle which is made by method of plastic ejection molding, wherein core handle is partially coated with plate-structured soft layer, so as to improve the grip. The other conventional handle structure for a screwdriver discloses a tool handle which is made by extrusion forming method, wherein the soft layer is coated on the core handle along the longitudinal direction. Another conventional handle structure for a screwdriver also discloses a tool handle made of buffering material, which is double colored (made by double ejection molding). Another conventional handle structure for a screwdriver discloses a tool handle which is made of two different materials.

The above-mentioned tool handles are made by two ejection molding processes, in first process the core handle is made and then soft layer is coated on the core handle in second process, and thus a double colored handle is formed. After that, a rod is inserted in the front of the handle. With this manner, the formed handle has only two colors, furthermore, it cannot be formed with trademark or patterns during the ejection molding process. Therefore, the production cost must be increased if print the trademark by mother methods after the handle is formed.

The present invention has arisen to mitigate and/or obviate the afore-described disadvantages of the conventional handle structure for screwdriver.

### SUMMARY OF THE INVENTION

The primary object of the present invention is to provide a tricolored handle structure for screwdriver. The tricolored handle structure is provided along the axial direction with a rod which extends outward from the handle, the handle has a hard-plastic made first core handle integrally melted with a hard-plastic made second core handle and then being coated with a soft third layer, the first core handle has at least a hard first pattern portion, the second core handle has at least a hard second pattern portion, wherein the first pattern portions and the pattern portion are not coated by third layer, the first pattern portion, the second pattern portion and the third layer are different colored and form a smooth surface of the handle.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a tricolored handle structure for screw driver with a rod in accordance with the present invention;

FIG. 2 is longitudinal cross sectional view of showing the condition of a tricolored handle structure for screw driver with a rod in accordance with the present invention in the third process ejection molding process;

FIG. 3 is longitudinal cross sectional view of showing the condition of a tricolored handle structure for screw driver with a rod in accordance with the present invention in the second process ejection molding process;

FIG. 4 is longitudinal cross sectional view of showing the condition of a tricolored handle structure for screw driver with a rod in accordance with the present invention in the first process ejection molding process;

FIG. 5 is an upside view of a tricolored handle structure for screw driver with a rod in accordance with the present invention in the first process ejection molding process.

FIG. 6 is an outside view of the final products of a tricolored handle structure for screwdriver in accordance with the present invention.

### DETAILED DESCRIPTION OF THE PREFERRED EMBODIMENT

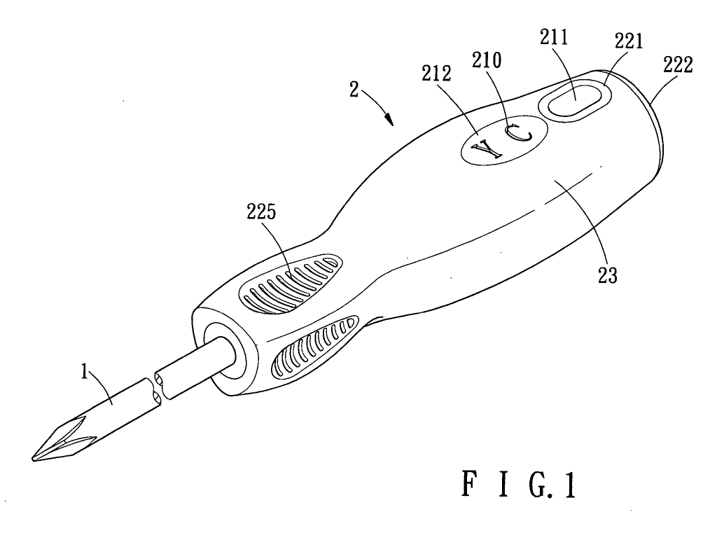

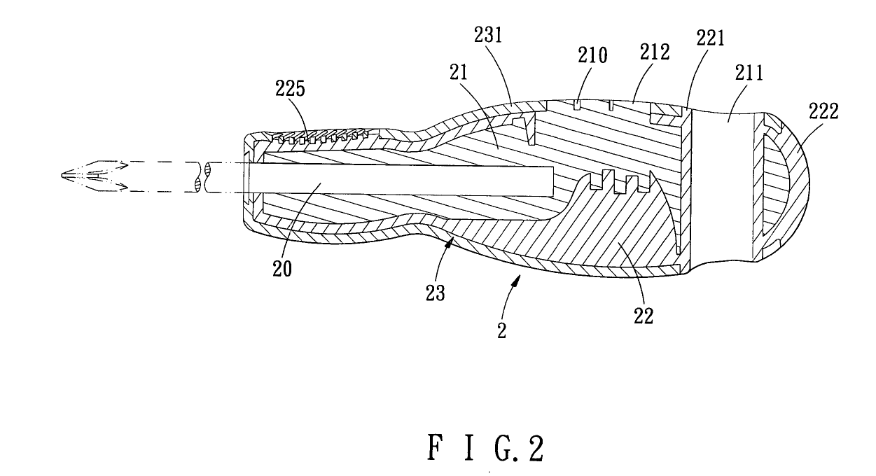

Referring to FIGS. 1 and 2, wherein a screwdriver with tricolored handle in accordance with the present invention is shown and generally comprised of a handle 2 and from which a rod 1 extends outward along the axial direction of the handle 2. The principle characteristic of the screwdriver is that the handle 2 includes a hard-plastic made first core handle 21 integrally melted with a hard-plastic made second core handle 22 and then is coated with a soft third layer 23. The first core handle 21 includes at least a rigid first pattern portion 212 with pattern on it, such as a trademark 210, the second core handle 22 includes at least a rigid second pattern portion 225 with pattern printed on it, such as striate. And then the first and the second cores 21, 22, except the first and the second pattern portions 212, 225, are exteriorly coated with a third layer 23. The first pattern portion 212, the second pattern portion 225 and the third layer 23 form a tricolored smooth surface 231 of the handle 2.

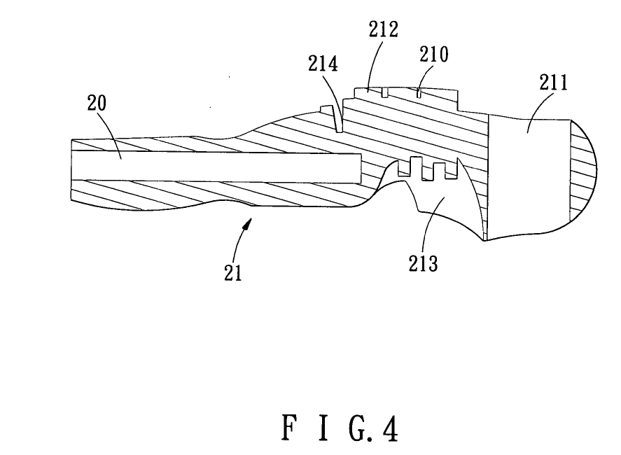

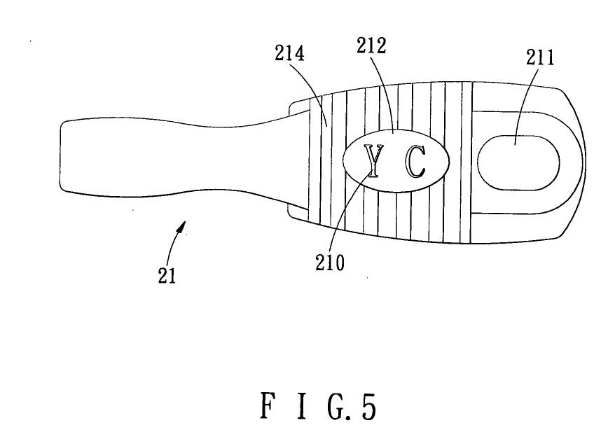

Referring to FIGS. 4 and 5, wherein a passage 20 is formed along the central axis of the first core handle 21 during the first process of ejection molding. The first core handle 21 is further provided with a protrusive first pattern portion 212 which will serve as a reference plane in next ejection molding process, on the first core handle 21 opposite to the first pattern portion 212 is formed with a sunken portion 213 which is defined with annular grooves, such that the first core handle 21 is possessed with rather even sectional area so as to prevent shrinkage distortion. The passage 20 serves to receive the rod 1 which serves as a reference plane in the next process. The molds in accordance with the present invention are operated in circular manner, thereby the parting lines of the respective molds of the present invention can be solved if the reference line of the passage 20 is well controlled. The first and the second core handles 21, 22 are made of PVC which is hard but not impact resistant and has a SHORE D hardness of 65 to 75. The first pattern portion 212 can be formed with trademark 210 (such as Y.C as shown in FIG. 1), it is more easy to be made if the trademark 210 is flat-formed, but if it is curve-formed that the corresponding mould also should have the same curvature, so as to prevent plastic material intrusion in the next process. In order to be well integrated, the first and the second core handles 21, 22 are at least formed with a first annular groove 214 and a second annular groove 224 which to be filled up for the next process. The hard first core handle 21 also can be formed with a through hole 211 for reception of a tool rod.

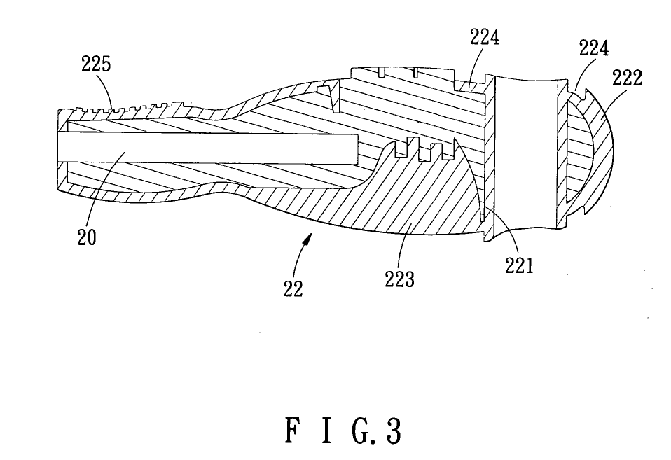

Referring to FIG. 3, during the second process of ejection molding, the first core handle 21 formed in the first process is set in the second mold, the first pattern portion 212 and the passage 20 act as reference plane, and then the second mold is closed. There are spaces left in the mold for a second layer 223, an end layer 222, a hole layer 221 and the second pattern portion 225. When different colored hard plastics are melted and ejected into the mould, it will flow into the spaces of the second mold except the first pattern portion 212, and the sunken portion 213, the annular grooves 214 will be filled up, in this way, the second core handle 22 is formed. In order to be well integrated in next process, the core handle 22 is additionally formed with at least a second annular groove 224 which is to be filled up in the next process. Now the second core handle 22 is fairly close to final product form, it only needs to be coated with a soft layer.

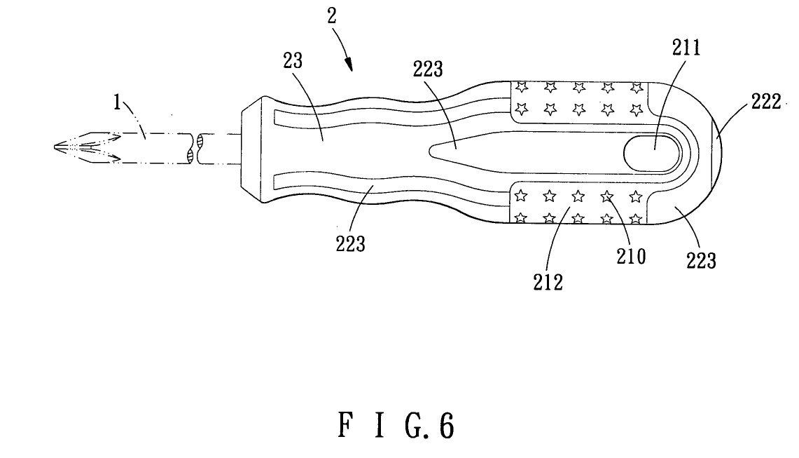

Referring again to FIGS. 1 and 2, or referring to FIG. 6 during third process of ejection molding, the formed second core handle 22 is set in a third mold which is then closed with the first pattern portion 212, the passage 20, the end layer 222 as reference plane. There is space left for the third layer 23. The first pattern portion 212 and the end layer 222 contact the surface of the third mold cavity. When different colored hard plastics are melted and ejected into the mould, it will flow into the space of the third mold except the first pattern portion 212, the end layer 222 and the hole layer 221, so as to form a soft third layer 23, and meanwhile form the smooth surface 231 of the handle 2, that is that almost there is no height difference among the first pattern portion 212, the second pattern portion 225 and the third layer 23, it can hardly be observed by eye. The soft third layer 23 is made of thermo-elastoplastic material which have SHORE A hardness of 35 to 75 and thickness 5 cm for improving grip.

While we have shown and described various embodiments in accordance with the present invention, it should be clear to those skilled in the art that further embodiments may be made without departing from the scope of the present invention.

1. A tricolored handle structure for screwdriver, along axial direction of the handle a rod extending outward from the handle, the handle having a hard-plastic made first core handle integrally melted with a hard-plastic made second core handle and then being coated with a soft third layer, the first core handle having at least a hard first pattern portion, the second core handle having at least a hard second pattern portion, wherein the first pattern portion and the pattern portion are not coated by third layer, the first pattern portion, the second pattern portion and the third layer are different colored and form a smooth surface of the handle.

2. The tricolored handle structure for screwdriver as claimed in claim 1, wherein the first core handle is formed in first process of ejection molding, the first core handle is defined along the central axis with a passage and it is further formed with the first pattern portion, opposite to the first pattern portion is a sunken portion which is defined with annular grooves, such that the first core handle is possessed with rather even sectional area so as to prevent shrinkage distortion.

3. The tricolored handle structure for screwdriver as claimed in claim 1, wherein the second core handle is at least defined with a second annular groove, so as to be well integrated in next ejection molding process.

4. The tricolored handle structure for screwdriver as claimed in claim 1, wherein the third layer is soft for improving the grip.

5. The tricolored handle structure for screwdriver as claimed in claim 1, wherein the first pattern portion is to be seted with trademark.
